(19) United States
(12) Patent Application Publication
(10) Pub. No.: US 2026/0122410 A1
(43) Pub. Date: Apr. 30, 2026

(54) DISPLAY APPARATUS

(71) Applicant: SAMSUNG ELECTRONICS CO., LTD., Suwon-si (KR)

(72) Inventors: Mingyu YOON, Suwon-si (KR); Seongsu PARK, Suwon-si (KR); Wooyoung CHEON, Suwon-si (KR); Sunmin KIM, Suwon-si (KR); Changjun LEE, Suwon-si (KR)

(73) Assignee: SAMSUNG ELECTRONICS CO., LTD., Suwon-si (KR)

(21) Appl. No.: 19/334,017

(22) Filed: Sep. 19, 2025

Related U.S. Application Data
(63) Continuation of application No. PCT/KR2025/013525, filed on Sep. 3, 2025.

(30) Foreign Application Priority Data
Oct. 25, 2024 (KR) 10-2024-0147870
Feb. 24, 2025 (KR) 10-2025-0023958

(51) Int. Cl. H04R 1/34; G06F 1/16; H04R 1/28

(52) U.S. Cl. CPC H04R 1/345; G06F 1/1601; H04R 1/2888; H04R 2499/15

(57) ABSTRACT

A display apparatus includes a display panel configured to display an image in a first direction; a chassis disposed on a rear side of the display panel; a rear cover configured to cover a rear side of the chassis; a speaker module including a diaphragm; and a holder configured to fix the speaker module to the rear cover such that the speaker module is disposed between the chassis and the rear cover, wherein the holder and the rear cover are configured to contact each other in the first direction to be sealed and be positioned in a direction opposite to a direction in which the diaphragm faces, thereby forming a chamber.

### CROSS-REFERENCE TO RELATED APPLICATIONS

This application is a continuation application, under 35 USC § 111(a), of International Application No. PCT/KR2025/013525, filed on Sep. 3, 2025, which claims priority to Korean Patent Applications No. 10-2024-0147870, filed on Oct. 25, 2024 and No. 10-2025-0023958, filed on Feb. 24, 2025, in the Korean Intellectual Property Office, the disclosure of which is incorporated by reference herein in its entirety.

### TECHNICAL FIELD

The disclosure relates to a display apparatus including a speaker.

### BACKGROUND ART

A display apparatus is a type of output device that converts acquired or stored electrical information into visual information for display to a user, and is configured to output not only visual information but also audio information.

The display apparatus may include a speaker for outputting audio information. The speaker is typically disposed on the rear or side of the display apparatus, and such a speaker may be a factor that increases the thickness of the display apparatus.

The thickness of display apparatuses is becoming thinner and thinner, and it is necessary to reduce the thickness of speakers in order to reduce the overall thickness of the display apparatus. However, when the thickness of the speaker is reduced, it is difficult to secure sufficient space for driving the speaker, which may deteriorate acoustic performance.

Accordingly, various attempts have been made for speakers that may provide excellent acoustic performance while reducing thickness, and display apparatuses including the same.

### SUMMARY

An aspect of the present disclosure provides a speaker that may provide excellent acoustic performance while reducing thickness, and a display apparatus including the same.

An aspect of the present disclosure provides a speaker including a speaker module that may provide excellent acoustic performance by forming an enclosure for the speaker module through a rear cover without any additional configuration, and a display apparatus including the same.

Technical tasks to be achieved in this document are not limited to the technical tasks mentioned above, and other technical tasks not mentioned will be clearly understood by those skilled in the art from the description below.

A display apparatus according to the present disclosure may include: a display panel configured to display an image in a first direction that is a front side of the display panel; a chassis positioned in an opposite direction to the first direction on a rear side of the display panel; a rear cover configured to cover a rear side of the chassis; a speaker module including a diaphragm, the diaphragm facing a second direction orthogonal to the first direction; and a holder configured to fix the speaker module to the chassis such that the speaker module is between the chassis and the rear cover; wherein the rear cover that covers the rear side of the chassis contacts the holder such that the holder and the rear cover form a chamber that is positioned in a direction opposite to the second direction in which the diaphragm faces and is sealed in the first direction.

### DESCRIPTION OF DRAWINGS

FIG. 1 is a perspective view of a display apparatus according to an embodiment.

FIG. 2 is a view showing a rear surface of the display apparatus according to an embodiment.

FIG. 3 is a view showing a cross-section of a display panel in the display apparatus according to an embodiment.

FIG. 4 is a view showing a state in which a rear cover of a display apparatus according to an embodiment is disassembled.

FIG. 5 is an exploded perspective view of some components of the display apparatus according to an embodiment.

FIG. 6 is a view showing a portion of the rear surface of the display apparatus according to an embodiment, in which the rear cover is shown transparently.

FIG. 7 is a view showing some components of a display apparatus according to an embodiment.

FIG. 8 is a view showing a portion of a rear cover of a display apparatus according to an embodiment.

FIG. 9 is a view showing a portion of the rear surface of the display apparatus according to an embodiment, in which the rear cover is shown transparently.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

In addition, the terms ‘portion’, ‘part’, ‘module’ and ‘member’ may be implemented in hardware or software. Depending on the embodiments, a plurality of ‘portions’, ‘parts’, ‘modules’, and ‘members’ may be implemented as a single element, or a single ‘portions, ‘part’, ‘module’, or ‘member’ may include a plurality of elements.

Also, the terms used herein are used to describe the embodiments and are not intended to limit and/or restrict the disclosure. The singular forms “a”, “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

When an element (e.g., a first element) is referred to as being “(functionally or communicatively) coupled” or “connected” to another element (e.g., a second element), the first element may be connected to the second element, directly (e.g., wired), wirelessly, or through a third element.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

The terms “up,” “down,” “front,” “rear,” and the like used in the following description may be defined with reference to the drawings, and the shape and position of each element are not limited by these terms. For example, the terms “front” and “rear” below may each be defined with reference to an +X direction and −X direction shown in the drawings, respectively. The terms “up” and “down” below may each be defined with reference to a +Z direction and −Z direction shown in the drawings. The terms “left” and “right” below may each be defined with reference to a +Y direction and −Y direction shown in the drawings. The terms “vertical direction” below may be defined with reference to the Z direction shown in the drawings, and the terms “horizontal direction” below may be defined with reference to the Y direction shown in the drawings.

Hereinafter, various embodiments of the disclosure will be described in detail with reference to the accompanying drawings.

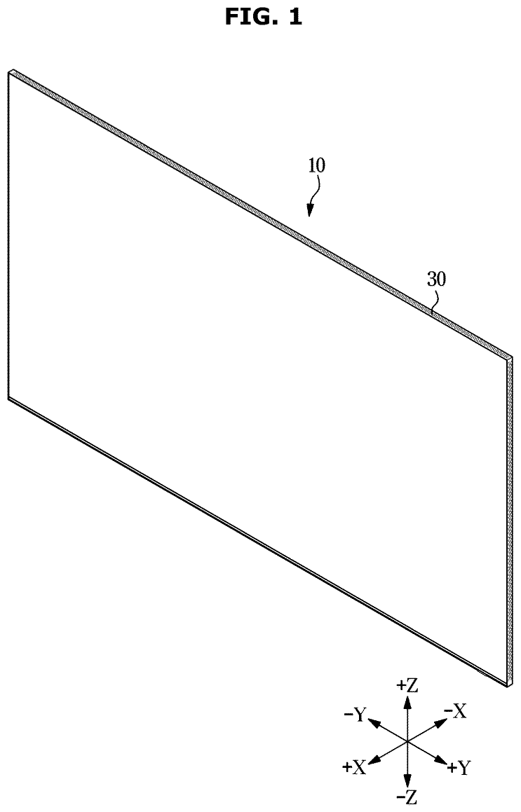

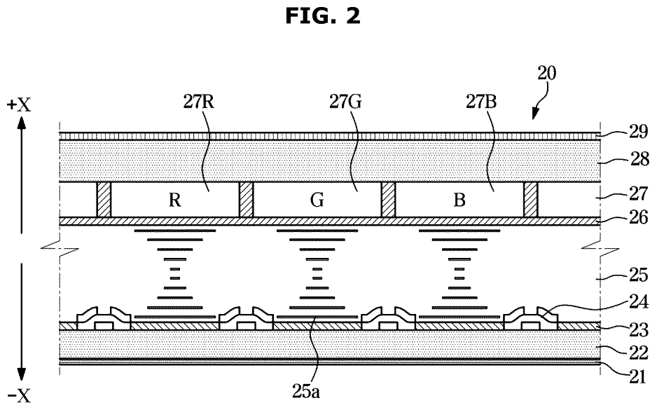

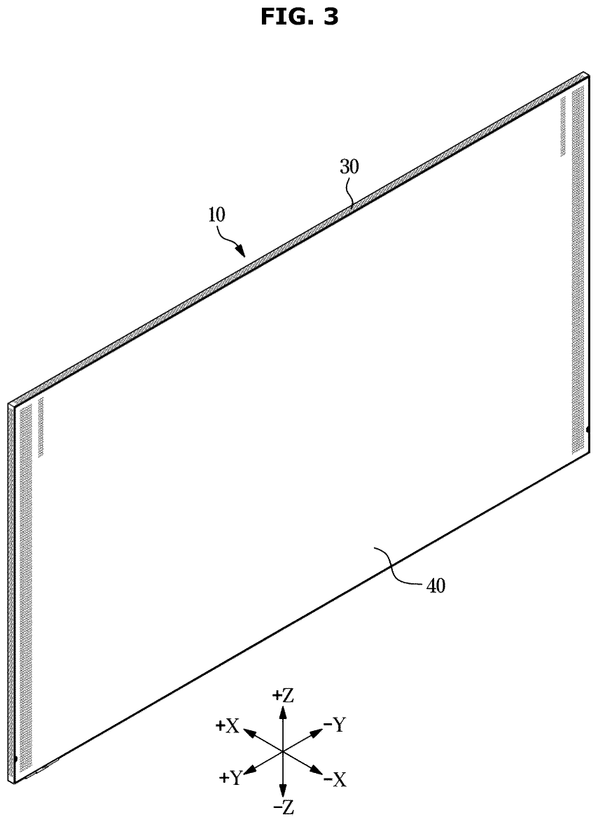

FIG. 1 is a perspective view of a display apparatus according to an embodiment, FIG. 2 is a view showing a rear surface of the display apparatus according to an embodiment, and FIG. 3 is a view showing a cross-section of a display panel in the display apparatus according to an embodiment.

Referring to FIG. 1, a display apparatus 10 may be an apparatus capable of processing image signals received from an external source and visually displaying the processed image. In the following, a case where the display apparatus 10 is a television (TV) is exemplified, but the present disclosure is not limited thereto. For example, the display apparatus 10 may be implemented in various forms, such as a monitor, a portable multimedia device, a portable communication device, or the like, and the display apparatus 10 is not limited to any form as long as it is an apparatus that visually displays images.

The display apparatus 10 may receive content data including video data and audio data from various content sources, and output video and audio corresponding to the video data and audio data. For example, the display apparatus 10 may receive content data via a broadcast receiving antenna or a wired cable, receive content data from a content playback device, or receive content data from a content delivery server of a content provider.

The display apparatus 10 may include a display panel 20 that displays video in a front direction +X. The front direction +X may also be referred to as a first direction X below.

The display apparatus 10 may include a front chassis 30 configured to cover side surfaces and at least a portion of a front surface of the display panel 20.

According to an embodiment, the display apparatus 10 may include a non-self-luminous panel. For example, the display apparatus 10 may include a display panel 20 and a backlight unit configured to provide light to the display panel 20. For example, the display panel 20 may be a liquid crystal panel. The liquid crystal panel may be configured to block or pass light from the backlight unit. The backlight unit may be disposed behind the liquid crystal panel to provide light to the liquid crystal panel. The liquid crystal panel may receive light from the backlight unit to form a screen of the display apparatus. For example, the display apparatus 10 may include a backlight unit, a quantum dot layer, a liquid crystal panel, and a color filter.

According to an embodiment, the display apparatus 10 may include a self-luminous panel. In this case, the display panel 20 may be configured to emit light by itself and may not include a backlight unit that provides light to the display panel 20. For example, the display panel 20 may be an organic light emitting diode (OLED) panel. For example, the display panel 20 may be a micro LED panel in which the LEDs are less than 100 micrometers (μm) in size.

The front chassis 30 may be configured to cover the side surfaces of the display panel 20. The front chassis 30 may be configured to cover at least a portion of the front surface of the display panel 20. Specifically, the front chassis 30 may be configured to cover a border of the front surface of the display panel 20. The front portion of the front chassis 30 exposed to the front surface of the display apparatus 10 may be referred to as a bezel.

The front chassis 30 may be formed to extend along the perimeter of the display panel 20. The front chassis 30 may be provided in an approximately rectangular ring shape. The front chassis 30 may protect the display panel 20 by covering the side surfaces and at least a portion of the front surface of the display panel 20, and may form the side appearance of the display apparatus 10. Also, the front chassis 30 may form part of the front appearance of the display apparatus 10.

Referring to FIG. 2, the display panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the thin film transistor 24, the liquid crystal layer 25, the common electrode 26, and the color filter 27. The first and second transparent substrates 22 and 28 may be made of tempered glass or transparent resin.

The first polarizing film 21 and the second polarizing film 29 may be provided on an outer side of the first and second transparent substrates 22 and 28, respectively.

The first polarizing film 21 and the second polarizing film 29 may each pass specific light and block other light. For example, the first polarizing film 21 passes light having a magnetic field oscillating in one direction and blocks other light. Also, the second polarizing film 29 passes light having a magnetic field oscillating in a direction orthogonal to the one direction and blocks other light. Thereby, the polarization direction of light passed by the first polarizing film 21 and the oscillation direction of light passed by the second polarizing film 29 may be orthogonal to each other. As a result, light generally cannot pass through both the first polarizing film 21 and the second polarizing film 29 simultaneously.

The color filter 27 may be provided on the inner side of the second transparent substrate 28.

The color filter 27 may include, for example, a red filter 27R that passes red light, a green filter 27G that passes green light, and a blue filter 27B that passes blue light, and the red filter 27R, the green filter 27G, and the blue filter 27B may be arranged side by side. The area where the color filter 27 is formed may correspond to pixels of the display panel 20. The area where the red filter 27R is formed may correspond to a red sub-pixel. The area where the green filter 27G is formed may correspond to a green sub-pixel. The area where the blue filter 27B is formed may correspond to a blue sub-pixel.

The pixel electrode 23 may be provided on the inner side of the first transparent substrate 22, and the common electrode 26 may be provided on the inner side of the second transparent substrate 28.

The pixel electrode 23 and the common electrode 26 are made of an electrically conductive metal material and may generate an electric field to change the arrangement of liquid crystal molecules 25a constituting the liquid crystal layer 25, which will be described below.

The pixel electrode 23 and the common electrode 26 are made of a transparent material and may pass light incident from the outside. For example, the pixel electrode 23 and the common electrode 26 may include Indium Tin Oxide (ITO), Indium Zinc Oxide (IZO), silver nanowire (Ag nano wire), carbon nanotube (CNT), graphene, PEDOT (3,4-ethylenedioxythiophene), or the like. The thin film transistor (TFT) 24 may be provided on the inner side of the first transparent substrate 22.

The TFT 24 may pass or block a current flowing to the pixel electrode 23. For example, an electric field may be created or removed between the pixel electrode 23 and the common electrode 26 in response to the turn-on (closing) or turn-off (opening) of the TFT 24.

The TFT 24 may be made of poly-silicon and may be formed by semiconductor processes, such as lithography, deposition, and ion implantation processes.

The liquid crystal layer 25 may be formed between the pixel electrode 23 and the common electrode 26. The liquid crystal layer 25 may be filled with liquid crystal molecules 25a.

Liquid crystal exhibits an intermediate state between solid (crystal) and liquid. Most liquid crystal materials are organic compounds, and the molecular shape thereof is a long, thin rod shape. The arrangement of molecules is irregular in some directions, but may have a regular crystal form in other directions. As a result, liquid crystal may have both the fluidity of a liquid and the optical anisotropy of a crystal (solid).

Also, liquid crystal may exhibit optical properties in response to changes in an electric field. For example, the orientation of the arrangement of molecules constituting the liquid crystal may change in response to changes in the electric field. When an electric field is generated in the liquid crystal layer 25, the liquid crystal molecules 25a of the liquid crystal layer 25 may be arranged according to the direction of the electric field, and when an electric field is not generated in the liquid crystal layer 25, the liquid crystal molecules 25a may be arranged irregularly or along an alignment film (not shown). As a result, the optical properties of the liquid crystal layer 25 may vary depending on the presence or absence of an electric field passing through the liquid crystal layer 25.

The structure of the display panel 20 described above with reference to FIG. 2 is merely an example of a structure that the display panel of the display apparatus according to the present disclosure may have, and the present disclosure is not limited thereto.

Referring to FIG. 3, the display apparatus 10 may include a rear cover 40 configured to cover the rear surfaces of the display panel 20 and a rear chassis 50, which will be described later.

The rear cover 40 may be configured to cover the rear surface of the display panel 20. The rear cover 40 may be disposed behind the display panel 20. The rear cover 40 may be provided in a size and shape corresponding to the display panel 20.

Hereinafter, a speaker module 100 and a holder 110, which are disposed between the rear chassis 50 and the rear cover 40 will be described in detail.

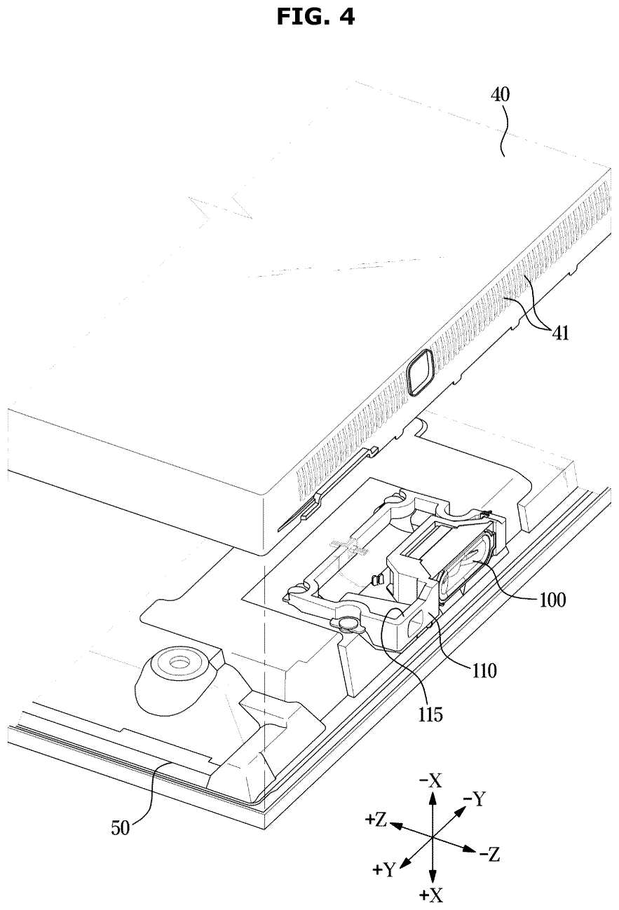

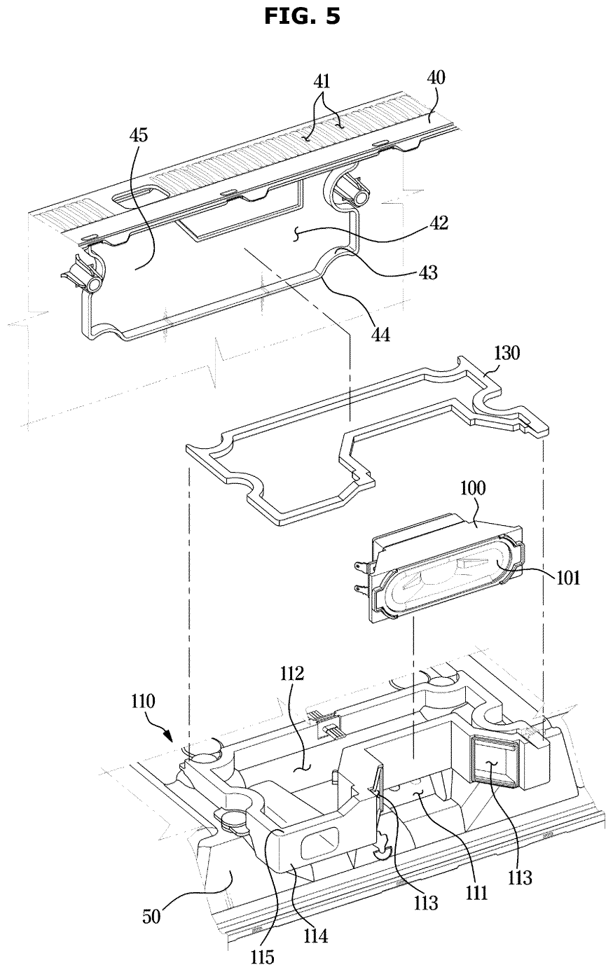

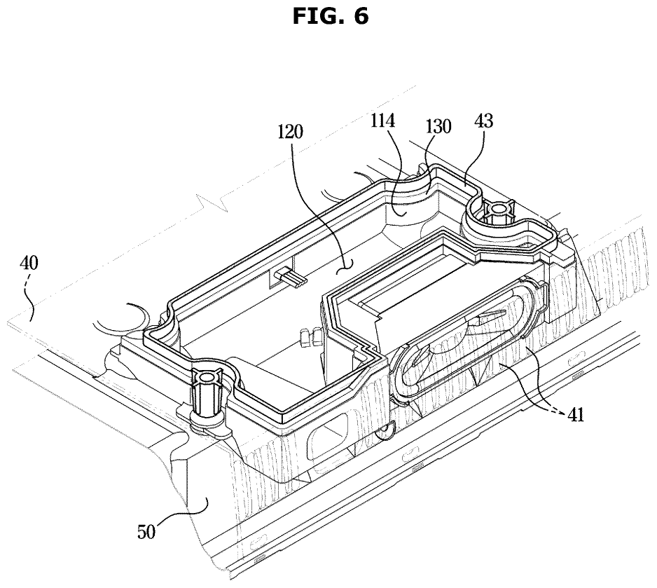

FIG. 4 is a view showing a state in which a rear cover of a display apparatus according to an embodiment is disassembled, FIG. 5 is an exploded perspective view of some components of a display apparatus according to an embodiment, and FIG. 6 is a view showing a portion of the rear surface of a display apparatus according to an embodiment, in which the rear cover is shown transparently.

The rear chassis 50 and the rear cover 40 shown in FIGS. 4 to 6 show only a portion adjacent to the speaker module 100 and holder 110 in the overall configuration for ease of description.

As shown in FIGS. 4 to 6, the display apparatus 10 may include the rear chassis 50. The rear chassis 50 may be disposed behind the display panel 20. When the display apparatus 10 includes a backlight unit, the rear chassis 50 may support the backlight unit. When the display apparatus 10 does not include a backlight unit, the rear chassis 50 may support the display panel 20. Also, the rear chassis 50 may support various components of the display apparatus 10, such as a control assembly and a power assembly.

The rear chassis 50 may be formed to have a substantially flat plate shape, but is not limited thereto. The rear chassis 50 may be configured to include a material with a high thermal conductivity to facilitate heat dissipation to the outside. For example, the rear chassis 50 may be configured to include metal materials such as aluminum and SUS, or plastic materials such as ABS.

The rear cover 40 may be arranged to be coupled to the rear chassis 50 in the first direction X from the rear-X of the rear chassis 50. The rear-X may also be referred to as the opposite direction −X of the first direction X.

The display apparatus 10 may include the speaker module 100 configured to output audio corresponding to audio data. The speaker module 100 may be disposed behind the display panel 20. The speaker module 100 may be disposed behind the rear chassis 50. The speaker module 100 may be disposed between the rear chassis 50 and the rear cover 40 in the opposite direction −X of the first direction.

The speaker module 100 may be provided in a plurality. Since the plurality of speaker modules 100 are all provided with the same configuration, hereinafter, one speaker module 100 and a corresponding holder 110 and portion of the rear cover 40 will be described.

The speaker module 100 may be configured to convert electrical signals into sound. The speaker module 100 may be configured to generate sound. The speaker module 100 may include a diaphragm 101 configured to vibrate upon receiving electrical signals.

The speaker module 100 may generate sound by moving the diaphragm 101.

For example, the speaker module 100 may include a fixing plate disposed at the center of the diaphragm 101, a magnet, a voice coil, and other components.

The speaker module 100 may be configured such that the diaphragm 101 faces downward −Z of the display apparatus 10. Accordingly, the speaker module 100 may be configured to radiate sound downward −Z of the display apparatus 10.

The display apparatus 10 may include the holder 110 configured such that the speaker module 100 is disposed between the rear chassis 50 and the rear cover 40.

The holder 110 may be configured to fix the speaker module 100 to the rear chassis 50.

The holder 110 may be configured to be coupled to the rear surface of the rear chassis 50 such that the speaker module 100 is disposed on the rear surface of the rear chassis 50. The holder 110 may be configured to seat the speaker module 100 such that the speaker module 100 is disposed on the rear surface of the rear chassis 50.

The holder 110 may support the speaker module 100 such that the diaphragm 101 of the speaker module 100 faces downward −Z of the display apparatus 10.

The holder 110 may include a seating portion 111 where the speaker module 100 is seated.

The seating portion 111 may be configured such that the speaker module 100 is seated on the holder 110 in an opposite direction −X of the first direction to the first direction X.

The seating portion 111 may be provided as a portion of the holder 110 where the speaker module 100 is seated such that the speaker module 100 is disposed on the rear surface of the rear chassis 50.

The rear cover 40 may cover the speaker module 100 such that the speaker module 100 is not exposed to the outside in the opposite direction −X of the first direction.

When the rear cover 40 is coupled to the rear chassis 50 from the rear-X, the rear cover 40 may cover the speaker module 100 and the holder 110 such that the speaker module 100 and the holder 110 disposed on the rear surface of the rear chassis 50 are not exposed in the opposite direction −X of the first direction.

The rear cover 40 may include an outlet 41 configured to allow sound waves radiated from the diaphragm 101 to travel to the outside of the display apparatus 10. The outlet 41 may be disposed in a position corresponding to the diaphragm 101.

The outlet 41 may be configured to open downward −Z from a lower end of the rear cover 40.

In the case of a conventional speaker module, the speaker module is inserted into an enclosure so that the forward waves radiated to the front of the diaphragm and the rearward waves radiated to the rear of the diaphragm are blocked from each other to improve the acoustic performance of the speaker module.

However, in the case of display a conventional a display apparatus, the enclosure configuration into which the speaker module is inserted is excluded from the display apparatus in consideration of the slimness of the display apparatus and manufacturing efficiency, and accordingly, the forward and rearward waves generated by the speaker module interfere with each other, resulting in a decrease in acoustic performance.

In other words, there is no configuration to separate the forward wave radiated to the front of the diaphragm and the rearward wave radiated to the rear of the diaphragm, so the sound generated by the speaker module is canceled out due to the forward and rearward waves interfering with each other and canceling each other out, resulting in a decrease in acoustic performance of the speaker module.

To prevent such a situation, the holder 110 and the rear cover 40 of the display apparatus 10 according to an embodiment may be configured to form a chamber 120 that serves as a corresponding role to a typical enclosure.

The display apparatus 10 may include the chamber 120, which is a space formed by the holder 110 and the rear cover 40.

The holder 110 and the rear cover 40 may form a chamber space (i.e., the chamber 120), which is sealed by being in contact with each other in the first direction X.

The chamber 120 may be positioned behind the speaker module 100 in the opposite direction Z of the direction −Z in which the diaphragm 101 faces.

The chamber 120 may be disposed behind the speaker module 100 or above the speaker module 100 in the display apparatus 10.

The holder 110 may include a first chamber portion 112 that forms a portion of the chamber 120.

The rear cover 40 may include a second chamber portion 42 that forms another portion of the chamber 120.

The first chamber portion 112 and the second chamber portion 42 may form the chamber 120 by forming the space that is sealed from the outside in the first direction X when the holder 110 and the rear cover 40 contact each other.

The chamber 120 may be configured to restrict the rearward wave, which is radiated in the direction opposite to the diaphragm 101, from propagating to the outside after being transferred, thereby preventing the forward and rearward waves from interfering and canceling each other.

The chamber 120 may be configured such that the rearward wave, which directed in the direction Z opposite to the direction in which the diaphragm 101 is directed, travel into the chamber 120.

The chamber 120 may be configured to block the rearward wave traveling inside the chamber 120 from traveling outside the chamber 120.

The holder 110 may include an opening 113 configured to communicate with the chamber 120 and with the speaker module 100 in the direction Z opposite to the direction in which the diaphragm 101 faces.

The rearward wave may propagate into the chamber 120 through the opening 113. The rearward wave traveling into the chamber 120 through the opening 113 may be separated from the forward wave radiated to the front of the diaphragm 101 through the chamber 120, thereby limiting interference or cancellation with the forward wave.

The opening 113 may be disposed at a position corresponding to the position where the rearward wave is radiated. For example, the opening 113 may be provided in a number corresponding to the point where the rearward wave is radiated. For example, a plurality of openings 113 may be provided.

For example, the opening 113 may be configured to be open toward the direction Z opposite to the direction in which the diaphragm 101 faces. For example, the opening 113 may be open in a direction where the rearward wave may easily travel and configured to guide the rearward wave to travel into the interior of the chamber 120.

The holder 110 may include a wall portion 114 configured to protrude in the opposite direction −X of the first direction and extend in a direction orthogonal to the first direction X to form the first chamber portion 112.

The wall portion 114 may be configured to enclose the chamber 120 as a closed space to limit the traveling of the rearward wave in the vertical and horizontal directions Y, −Y, Z, and −Z orthogonal to the first direction X.

The wall portion 114 may be configured in a shape that surrounds the rear of the speaker module 100 in the direction Z opposite to the direction in which the diaphragm 101 faces.

Accordingly, the chamber 120 may be disposed behind the speaker module 100 in the direction Z opposite to the direction in which the diaphragm 101 faces.

The opening 113 may be formed in a portion of the wall portion 114.

For example, the wall portion 114 may include a port configured such that the rearward wave in the chamber 120 travels in the direction Z in which the diaphragm 101 faces. However, the port configuration may not be formed.

The holder 110 may include a contact portion 115 positioned at the top of the wall portion 114 in the opposite direction −X of the first direction and configured to contact and seal with the rear cover 40.

The contact portion 115 may be provided as a portion that contacts the rear cover 40.

The contact portion 115 may be defined as an entire top of the wall portion 114 in the opposite direction −X of the first direction.

The contact portion 115 may be defined as an entire portion that contacts the rear cover 40 in the opposite direction −X of the first direction.

The contact portion 115 may be configured to form an upper portion of the first chamber portion 112 in the opposite direction −X of the first direction.

The rear cover 40 may include a contact rib 43 that protrudes in the first direction X and is configured to contact the contact portion 115.

The contact rib 43 may extend in the direction orthogonal to the first direction X in a shape corresponding to the wall portion 114.

The contact rib 43 may form the second chamber portion 42 together with at least a portion of the inner surface of the rear cover 40.

A front end 44 of the contact rib 43 in the first direction X may be configured to contact the contact portion 115.

As the front end 44 of the contact rib 43 and the contact portion 115 contact in the first direction X, the chamber 120 may be configured to be sealed in the first direction (X).

Accordingly, the chamber 120 may perform a function corresponding to an enclosure configuration to improve the acoustic performance of the speaker module 100 without additional configuration.

The contact rib 43 may be integrally molded with the rear cover 40 to protrude from the inner surface of the rear cover 40.

The contact rib 43 may be provided as a separate configuration from the rear cover 40 and coupled to the inner surface of the rear cover 40 to be protruded from the inner surface of the rear cover 40.

The contact rib 43 may be provided as a separate configuration from the rear cover 40 and configured to be bonded to the inner surface of the rear cover 40.

The contact rib 43 may be provided as a separate configuration from the rear cover 40 and configured to be fixed to the inner surface of the rear cover 40.

The display apparatus 10 may include a sealing member 130 disposed between the contact portion 115 and an upper end 44 of the contact rib 43 and configured to seal the contact portion 115 and the upper end 44 of the contact rib 43.

The sealing member 130 may extend in a shape corresponding to the contact portion 115 and the upper end 44 of the contact rib 43 in the direction orthogonal to the first direction X.

For example, the sealing member 130 may be disposed on the contact portion 115. The sealing member 130 may be coupled on the contact portion 115.

For example, the sealing member 130 may be disposed on the upper end 44 of the contact rib 43. The sealing member 130 may be coupled on the upper end 44 of the contact rib 43.

The sealing member 130 may be tightly coupled with the contact portion 115 and the contact rib 43 to improve the sealing performance of the chamber 120 in the first direction X.

For example, the sealing member 130 may be formed of an elastic material.

For example, the sealing member 130 may be configured in a shape corresponding to the contact portion 115 in the first direction X.

For example, the sealing member 130 may be configured in a single loop shape extending along the contact portion 115.

For example, the sealing member 130 may be provided in a plurality. The plurality of sealing members 130 may each be disposed on the contact portion 115 to form a loop extending along the contact portion 115.

Although the contact portion 115 and the contact rib 43 do not directly contact each other due to the sealing member 130, the sealing member 130 may be in close contact with the contact portion 115 and the contact rib 43, respectively, thereby sealing the chamber 120.

For example, the display apparatus 10 may not include the sealing member 130, and the contact portion 115 and the top of the contact rib 43 may directly contact each other and configured to seal the chamber 120.

Hereinafter, a holder 210 according to an embodiment of the present disclosure will be described in detail.

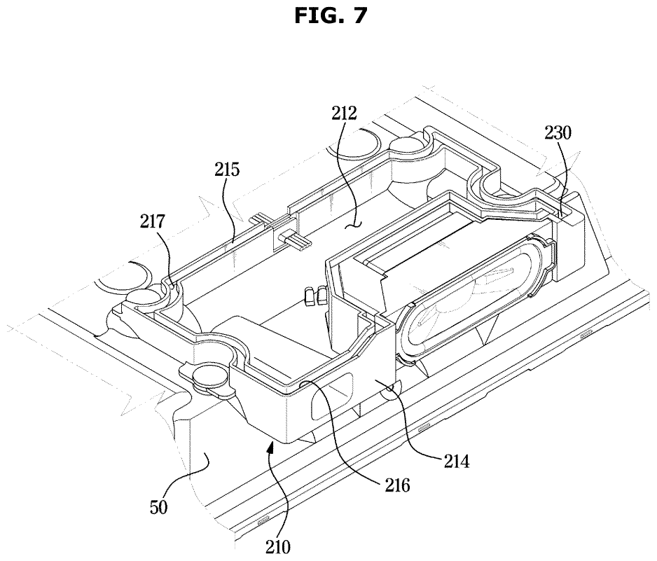

FIG. 7 is a view showing some components of a display apparatus according to an embodiment.

The holder 210 may include a wall portion 214 protruding in the opposite direction −X of the first direction and extending in a direction orthogonal to the first direction X to form a first chamber portion 212.

The holder 210 may include a contact portion 215 formed to be concave in the first direction X from an upper end 216 of the wall portion 214 in the opposite direction −X of the first direction.

The contact portion 215 may include a concave space formed at the upper end 216 of the wall portion 214.

At least a portion of the rear cover 40 may be inserted into the contact portion 215 and contact the contact portion 215, thereby being coupled to the holder 210.

The contact rib 43 of the rear cover 40 may be configured to be inserted into the contact portion 215 in the first direction X.

The contact rib 43 may be configured to be inserted into and contact the contact portion 215 to be coupled thereto.

As the contact rib 43 is inserted into the contact portion 215, the coupling area increases, which may result in improved the coupling force, and the increased sealing area may result in improved sealing performance.

For example, the display apparatus 10 may include a sealing member 230 inserted into an internal space 217 of the contact portion 215.

The sealing member 230 may be inserted into the internal space 217 of the contact portion 215 and the contact rib 43 may be inserted into the contact portion 215, so that sealing member 230 may contact the contact rib 43.

The sealing member 230 may be in close contact with the contact rib 43 and the contact portion 215 in the internal space 217 of the contact portion 215, thereby improving the sealing performance.

For example, the display apparatus 10 may not include the sealing member 230, and the contact rib 43 may be inserted into the contact portion 215, so that the contact rib 43 and the contact portion 215 directly contact each other to seal the chamber 120.

Hereinafter, the rear cover 40 according to an embodiment of the present disclosure will be described in detail.

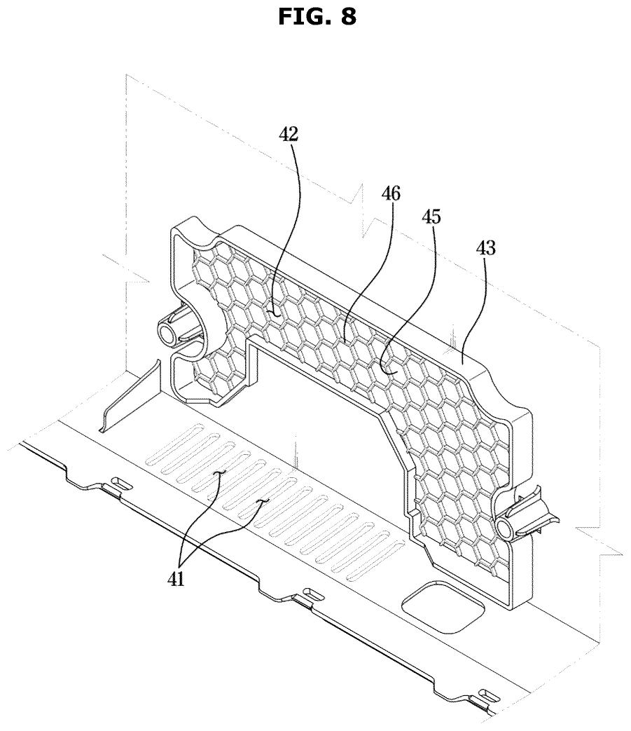

FIG. 8 is a view showing a portion of a rear cover of a display apparatus according to an embodiment.

The rear cover 40 may include a rigid member 46 provided inside the chamber 120 and disposed on an inner surface 45 of the contact rib 43 which form the second chamber portion 42.

The rigid member 46 may be configured to secure rigidity of the chamber 120 against resonance generated by the rearward wave traveling inside the chamber 120.

When the chamber 120 vibrates due to resonance, vibrations may be transmitted to the rear cover 40 and/or the rear chassis 50, which may reduce the reliability of the display apparatus 10. The rigid member 46 may limit the chamber 120 from vibrating by securing rigidity against resonance generated by the rearward wave.

For example, the rigid member 46 may be configured as a frame having a plurality of honeycomb shapes.

For example, the rigid member 46 may be disposed on the inner surface 45 on which the frame formed by the plurality of ribs forms the chamber 120.

For example, the rigid member 46 may be disposed on the inner surface of the contact rib 43.

For example, the rigid member 46 may be disposed on a surface of the holder 110 constituting the first chamber portion 112, instead of the inner surface 45 of the rear cover 40.

For example, a plurality of rigid members 46 may be disposed on a surface constituting the first chamber portion 112, in the inner surface 45 of the rear cover 40 and the holder 110.

For example, the rigid member 46 may include an acoustic meta-material configured to control noise vibration at a specific frequency.

For example, the rigid member 46 may be formed of an acoustic meta-material. For example, the frame of the rigid member 46 may be formed of an acoustic meta-material.

Hereinafter, a rear cover 40 and holder 110 according to an embodiment of the present invention will be described in detail.

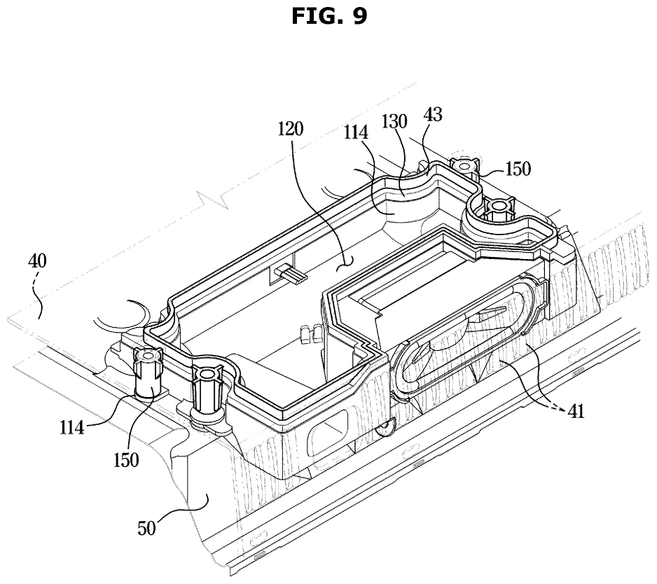

FIG. 9 is a view showing a portion of a rear surface of a display apparatus according to an embodiment, in which the rear cover is shown transparently.

The display apparatus 10 may include a pressing member 150 configured to press the rear cover 40 toward the rear chassis 50 so that the contact portion 115 and the contact rib 43 are in close contact.

The rear cover 40 may include a coupling hole 48 configured such that the pressing member 150 penetrates the rear cover 40 and couples to the rear chassis 50.

The coupling hole 48 may be open toward the opposite direction −X of the first direction, and the pressing member 150 may be configured to be inserted into the coupling hole 48 in the first direction X.

The pressing member 150 may be configured to press the rear cover 40 toward the rear chassis 50 while being coupled to the rear chassis 50 through the coupling hole 48.

The holder 110 may include a coupling portion 119 provided at a position corresponding to the coupling hole 48 and configured to couple to the pressing member 150.

For example, the coupling portion 119 may be configured such that the pressing member 150 penetrates the coupling portion 119 and couples to the rear chassis 50.

For example, the coupling portion 119 may be provided in a hole shape so that the pressing member 150 penetrates and may be configured to couple to the coupling portion 119 as the pressing member 150 penetrates.

For example, the pressing member 150 may be configured to be inserted into the coupling portion 119. For example, the coupling portion 119 may include an insertion groove into which the pressing member 150 is inserted.

The pressing member 150 may be configured to penetrate the rear cover 40 and be screw-coupled to the rear chassis 50.

For example, the pressing member 150 may be configured to penetrate the rear cover 40 and be screw-coupled to the coupling portion 119 of the holder 110.

As the pressing member 150 is screw-fastened, the rear cover 40 may be tightly fixed to the rear chassis 50, and in conjunction therewith, the contact portion 115 and the contact rib 43 may be brought into close contact with each other, thereby improving the sealing performance of the chamber 120.

While the present disclosure has been particularly described with reference to exemplary embodiments, it should be understood by those of skilled in the art that various changes in form and details may be made without departing from the spirit and scope of the present disclosure.

1. A display apparatus comprising:
a display panel configured to display an image in a first direction that is a front side of the display panel;
a chassis positioned in an opposite direction to the first direction on a rear side of the display panel;
a rear cover configured to cover a rear side of the chassis;
a speaker module including a diaphragm, the diaphragm facing a second direction orthogonal to the first direction; and
a holder configured to fix the speaker module to the chassis such that the speaker module is between the chassis and the rear cover;
wherein the rear cover that covers the rear side of the chassis contacts the holder such that the holder and the rear cover form a chamber that is positioned in a direction opposite to the second direction in which the diaphragm faces and is sealed in the first direction.

2. The display apparatus according to claim 1, wherein the chamber is configured to:
allow sound waves radiated from the diaphragm directed in the direction opposite to the second direction in which the diaphragm faces to travel inside the chamber, and
block the sound waves traveling inside chamber from traveling outside the chamber.

3. The display apparatus according to claim 2, wherein
the holder includes an opening configured to communicate with the chamber and with the speaker module in the direction opposite to the second direction in which the diaphragm faces, and
the sound waves are configured to travel inside the chamber through the opening.

4. The display apparatus according to claim 1, wherein the holder includes:
a wall portion protruding in the opposite direction of the first direction and extend in a direction orthogonal to the first direction and the second direction to form the chamber, and
a contact portion positioned at an upper end of the wall portion in the opposite direction of the first direction and configured to contact and seal with the rear cover.

5. The display apparatus according to claim 4, wherein the rear cover includes a contact rib protruding in the first direction and contact the contact portion.

6. The display apparatus according to claim 4, wherein the holder includes a seating portion on an outer side of the wall portion in the direction orthogonal to the first direction and the second direction, wherein the speaker module is seated on the seating portion.

7. The display apparatus according to claim 1, wherein the rear cover is configured to cover the speaker module, and includes an outlet to allow sound waves directed in the second direction in which the diaphragm faces to travel to an outside of the rear cover.

8. The display apparatus according to claim 5, further comprising a sealing member between the contact portion and the contact rib to seal the contact portion and the contact rib.

9. The display apparatus according to claim 8, wherein the sealing member is on the contact portion and extends along the contact portion in the direction orthogonal to the first direction and the second direction.

10. The display apparatus according to claim 5, wherein
the contact portion is concave in the first direction from the upper end of the wall portion, and
the contact rib is insertable into and contactable with the contact portion.

11. The display apparatus according to claim 5, further comprising a pressing member configured to press the rear cover toward the chassis such that the contact portion and the contact rib are in contact.

12. The display apparatus according to claim 11, wherein
the rear cover includes a coupling hole that opens in the first direction such that the pressing member penetrates the rear cover and couples to the chassis, and
the pressing member is configured to press the rear cover toward the chassis while being coupled to the chassis through the coupling hole.

13. The display apparatus according to claim 11, wherein the pressing member penetrates the rear cover and to screw-couple with the chassis.

14. The display apparatus according to claim 5, further comprising a rigid member in a plurality of honeycomb shapes on at least one surface inside the chamber.

15. The display apparatus according to claim 14, wherein the rigid member is on the rear cover and positioned on an inner side of the chamber.
